(19) United States
(12) Patent Application Publication
(10) Pub. No.: US 2012/0055156 A1
(43) Pub. Date: Mar. 8, 2012

(54) EXHAUST GAS RECIRCULATION SYSTEM FOR A COMBUSTION ENGINE

(75) Inventors: Karsten Grimm, Aachen (DE); Andres Toennesmann, Aachen (DE); Sven Nigrin, Duesseldorf (DE); Peter Haushaelter, Moenchengladbach (DE)

(73) Assignee: Pierburg GmbH, Neuss (DE)

(21) Appl. No.: 13/265,135

(22) PCT Filed: Mar. 16, 2010
(86) PCT No.: PCT/EP2010/053386

§ 371 Date: Oct. 20, 2011

(30) Foreign Application Priority Data
Apr. 24, 2009 (DE) 10 2009 018 525.9

(51) Int. Cl. F02M 25/07; F02B 47/08

(52) U.S. Cl. 60/605.2; 123/568.11

(57) ABSTRACT

An exhaust gas recirculation system for an internal combustion engine includes an exhaust gas duct, a suction duct, and an exhaust gas recirculation duct which branches off from the exhaust gas duct and which flows into the suction duct. An exhaust gas mass flow sensor is arranged downstream of a flow stabilization element in the exhaust gas recirculation duct.

### CROSS REFERENCE TO PRIOR APPLICATIONS

This application is a U.S. National Phase application under 35 U.S.C. §371 of International Application No. PCT/EP2010/053386, filed on Mar. 16, 2010 and which claims benefit to German Patent Application No. 10 2009 018 525.9, filed on Apr. 24, 2009. The International Application was published in German on Oct. 28, 2010 as WO 2010/121867 A1 under PCT Article 21(2).

### FIELD

The present invention provides an exhaust gas recirculation system for an internal scombustion engine comprising an exhaust gas duct and an exhaust gas recirculation duct which branches off the exhaust gas duct and opens into an intake duct.

### BACKGROUND

Systems already exist which recirculate exhaust gas to reduce the emission of pollutants. It is a common practice to arrange, in the exhaust gas recirculation duct, an exhaust gas recirculation valve and an exhaust gas cooler by which the temperature of the recirculated exhaust gas can be lowered after the heat-up phase. An additional reduction of the pollutants generated in the combustion process is thereby achieved.

Modern internal combustion engines are mostly turbo-charged engines comprising two exhaust gas recirculation lines. In these engines, a first line is arranged in the high-pressure region of the internal combustion engine, and a second line is arranged in the low-pressure region of the internal combustion engine. An increase of the recirculated exhaust gas mass flow with a simultaneous temperature control is thereby possible. An exhaust gas recirculation valve and an exhaust gas cooler, which optionally can be bypassed by a bypass duct, are also normally arranged in the high-pressure line.

An oxidation catalyst can also be arranged in the exhaust gas line. The oxidation catalyst serves to convert unburned exhaust gas components such as CO and HC. The oxidation catalyst consists of a metallic or ceramic honeycomb body which is provided with an oxidation-catalytic coating. Such a catalyst is temperature-dependent, which means that its efficiency will deteriorate if the exhaust gas temperature is too low. The arrangement of such a catalyst is described in DE 10 2005 024 984 A1.

In order to reduce the contamination of the exhaust gas recirculation valve and of the exhaust gas cooler in the high-pressure exhaust gas recirculation line, DE 10 2005 049 309 A1 and DE 10 2004 042 454 A1 describe arranging an oxidation catalyst upstream of the exhaust gas recirculation valve and respectively upstream of the exhaust gas cooler in the high-pressure exhaust gas recirculation line.

DE 10 2005 049 309 A1 and DE 10 2004 042 454 A1 do not, however, suggest how the exhaust gas quantity in the high-pressure exhaust gas recirculation duct could be measured and/or controlled.

DE 198 38 703 A1 also describes arranging a flow conducting body upstream of a catalyst so as to obtain a uniform flow through the catalyst.

For realizing the best possible precision in the dosed supply of air and recirculated exhaust gas to the internal combustion engine, DE 10 2006 038 863 A1 describes arranging a first mass air meter in the suction duct upstream of the mouth of the low-pressure exhaust gas recirculation duct, and arranging a second mass air meter in the suction duct downstream of the mouth of the low-pressure exhaust gas recirculation duct as well as upstream of the mouth of the high-pressure exhaust gas recirculation duct. The exhaust gas flows in the exhaust gas recirculation ducts can be estimated and controlled by these two sensors. This arrangement additionally uses a suction underpressure sensor, a pressure sensor upstream of the mouth of the high-pressure exhaust gas recirculation duct, an exhaust elbow pressure sensor, a pressure sensor in the low-pressure exhaust gas recirculation duct and an air charge temperature sensor in the suction line. As a result of various measurements, a differential equation by which the low-pressure exhaust gas is computed is obtained. The result is used to also calculate the exhaust gas flow in the high pressure circuit on the basis of the measured air quantities by differentiation.

Such a control process is very complex and requires highly complex equipment. Inaccurate measurement results will further be caused, particularly for the exhaust gas mass flow in the high-pressure exhaust gas recirculation duct, because this flow will first need to be calculated from various values, which themselves are subject to measurement errors, so that an amplification of measurement errors is expected.

### SUMMARY

An aspect of the present invention is to provide an exhaust gas recirculation system which makes it possible to measure the exhaust gas mass flow with utmost precision, so as to allow for improved control of an internal combustion engine.

In an embodiment, the present invention provides an exhaust gas recirculation system for an internal combustion engine which includes an exhaust gas duct, a suction duct, and an exhaust gas recirculation duct which branches off from the exhaust gas duct and which flows into the suction duct. An exhaust gas mass flow sensor is arranged downstream of a flow stabilization element in the exhaust gas recirculation duct. The exhaust gas mass flow sensor allows for direct measurement of the exhaust gas mass flow in the high-pressure exhaust gas recirculation duct. The arrangement behind the flow stabilization element generates a uniform flow onto the exhaust gas mass flow sensor, which otherwise would not occur because, in the exhaust gas recirculation duct, there normally prevail high exhaust gas pulsations and a massively inhomogeneous flow distribution which would lead to an adulteration of the measurement results. These measures allow for an exact measurement of the exhaust gas quantities, which at the same time improve the control of the internal combustion engine.

### BRIEF DESCRIPTION OF THE DRAWING

The present invention is described in greater detail below on the basis of embodiments and of the drawings in which:

FIG. 1 shows an embodiment of an exhaust gas recirculation system according to the present invention by way of a turbo-charged internal combustion engine.

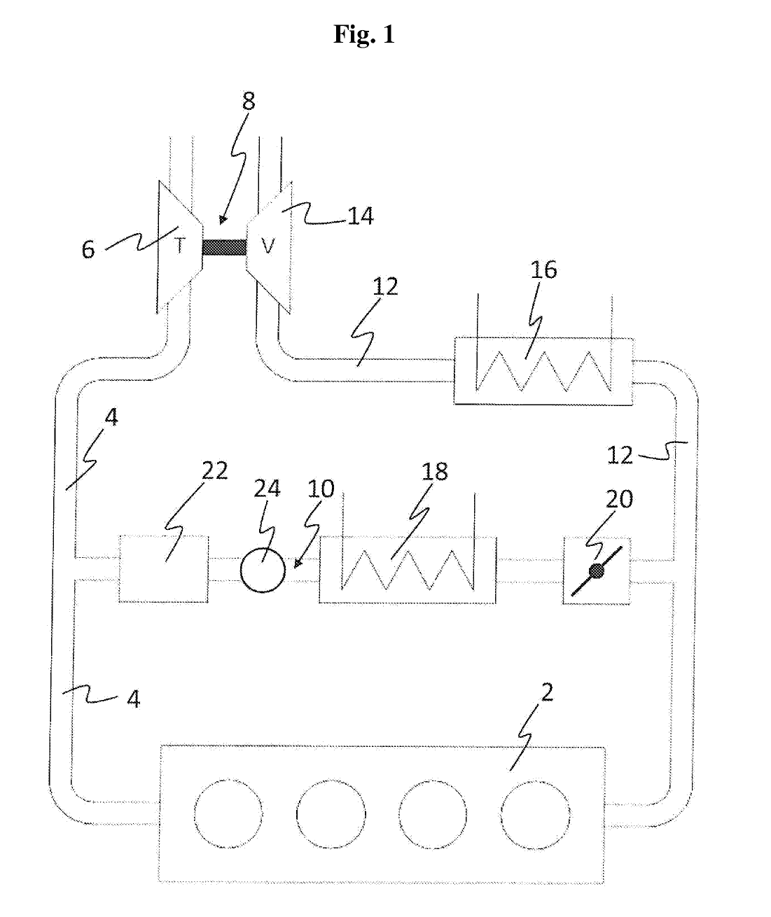

### DETAILED DESCRIPTION

In an embodiment of the present invention, the exhaust gas mass flow sensor can, for example, be arranged upstream of an exhaust gas cooler and an exhaust gas recirculation valve in the exhaust gas recirculation duct. This arrangement has the advantage that the resultant high temperatures will largely prevent the formation of a condensate on the exhaust gas mass flow sensor. Due to the high temperatures, the formation of soot will also be low. This measure therefore also contributes to an improvement of the achievable measurement results.

In an embodiment of the present invention, the flow stabilization element can, for example, be a catalyst, thus obviating the need for additional expenditure in equipment. Catalysts normally consist of coated plates which achieve a stabilization of the exhaust gas flow so that this function will also be automatically fulfilled.

In an embodiment of the present invention, the catalyst can, for example, be an oxidation catalyst. The latter consists of a honeycomb body normally coated with platinum, with the flow through the honeycomb body resulting in high uniformity and homogeneity of the discharged gas flow. The oxidation catalyst is further effective to avoid sooting in the region farther downstream, which again improves the measurement accuracy of the exhaust gas mass flow sensor.

In an embodiment of the present invention, the exhaust gas recirculation duct can, for example, be a high-pressure exhaust gas recirculation duct which, upstream of a turbine of a turbo charger, branches off from the exhaust gas duct and which, downstream of a condenser of the turbo charger, enters into the suction duct. The arrangement according to the present invention can be used with particular advantage, for example, in the high pressure region of an internal combustion engine, since, here, upstream of the optional diesel particulate filter, the return path is arranged close to the combustion chambers where high temperatures and pulsations prevail and where, normally, no cleaned exhaust gas will exist.

In an embodiment of the present invention, the exhaust gas mass flow sensor can, for example, operate according to the principle of hot-film anemometry. This principle has already proven to be a reliable and accurate system in air mass sensors. Such sensors are described in DE 10 2005 061 533 B4. They are largely insensitive to soot and other contamination in the exhaust gas since these kinds of contamination can be burned off.

An exhaust gas recirculation system is therefore provided wherein the exhaust gas mass flow can be measured in an exhaust gas recirculation duct, and particularly in a high-pres sure exhaust gas recirculation duct, with high accuracy due to avoidance of flow pulsations and inhomogeneities, thereby also making it possible to achieve a more precise control of the exhaust gas recirculation rate and of the combustion process within the combustion engine.

An exemplary embodiment of an exhaust gas recirculation system according to the present invention is schematically illustrated in the FIGURE by way of a turbo-charged internal combustion engine, and will hereinafter be described.

The exhaust gas recirculation system according to the present invention comprises a motor block 2 in which a combustion of a fuel/air mixture with simultaneous supply of exhaust takes place in a known manner. From motor block 2, an exhaust gas duct 4 first leads, in the form of an exhaust elbow, to a turbine 6 of a turbine charger 8 and, from there, onward to an exhaust gas discharge site, not shown, upstream of which (when viewed in flow direction) an exhaust gas flap as well as a branch-off duct of a low-pressure exhaust gas recirculation duct can be provided, the branch-off duct in turn having an exhaust gas recirculation valve arranged in it.

Upstream of turbine 6, a high-pressure exhaust gas recirculation duct 10 branches off from exhaust gas duct 4. This high-pressure exhaust gas recirculation duct 10 enters a suction channel 12 of the internal combustion engine, in which there are arranged, upstream of the mouth of high-pressure exhaust gas recirculation duct 10, a condenser 14 of the turbo charger 8 and, downstream of the turbo charger, a charging air cooler 16. The optional low-pressure exhaust gas recirculation duct enters into the suction channel 12 at a site upstream of condenser 14 so that the charging air cooler 16 will in this case already receive an exhaust gas/air mixture. The low-pressure exhaust gas recirculation duct serves to reduce the temperature of the sucked air so as to improve the combustion process.

Arranged in the high-pressure exhaust gas recirculation duct 10 are an exhaust gas cooler 18 and, downstream thereof, an exhaust gas recirculation valve 20, wherein the exhaust gas recirculation valve 20 could also be arranged upstream of the exhaust gas cooler 18 when seen in flow direction. Upstream of the exhaust gas cooler 18 and of the exhaust gas recirculation valve 20, an oxidation catalyst 22 is arranged in the high-pressure exhaust gas recirculation duct 10. Oxidation catalyst 22 normally consists of gas guide plates coated with a precious metal such as, for example, platinum, said plates mostly forming a honeycomb body.

The present invention provides that, between oxidation catalyst 22 and exhaust gas cooler 18, an exhaust-gas mass flow sensor 24 is arranged for measuring the exhaust-gas mass flowing through the exhaust gas recirculation duct 10. The result can be transmitted as a signal to an engine control unit, not shown, and can be used to set the exhaust gas recirculation valve 20 as well as for further motor control.

Exhaust gas which, after combustion has been discharged from motor block 2 into exhaust gas duct 4, will partly flow via the continuing exhaust gas duct 4 in the direction of the turbine 6 and partly into the high-pressure exhaust gas recirculation duct 10, depending on the opening degree of exhaust gas recirculation valve 20. The exhaust gas flow will here first reach the oxidation catalyst where the exhaust gas will contact the catalytic coating of the catalyst. This will cause, inter alia, an oxidation of the hydrocarbons in the exhaust gas, resulting in the generation of carbon dioxide and water. Oxidation catalyst 22 is additionally effective as a flow stabilization element since the gas guide plates, due to their arrangement, will eliminate the inhomogeneities existing in the exhaust gas flow and the pulsations caused by the pulsating discharge from the combustion chamber. The exhaust gas flow will therefore be uniform downstream of oxidation catalyst 22.

This exhaust gas flow will then reach the exhaust gas mass flow sensor 24 operating according to the principle of hot-film anemometry. This means that heating resistors of the sensor will be heated while, through convection, the generated heat of these heating resistors is transferred to the flowing medium. The resultant temperature change of the heating resistor or the additional power input for achieving the heating resistor temperature are a measure for the existing mass flow. These sensors operate highly reliably. One only has to take care to avoid deposits on the surfaces, so that, in use in the exhaust gas system, there are normally provided additional heating wires for burning off the deposits. Due to the uniform exhaust gas flow, very exact measurement results can be obtained from the exhaust gas mass flow sensor 24. Soot formation on the surface of the exhaust gas mass flow sensor will also be reduced by the arrangement downstream of the oxidation catalyst because, as a result of the reduced portion of hydrocarbons which tend to accumulate on the surface of the exhaust-gas mass flow sensor 24, less soot will accumulate on the surface.

A further advantage of this arrangement of the exhaust-gas mass flow sensor 24 is its position upstream of the exhaust gas cooler 18, whereby condensation of the water contained in the exhaust gas and of other exhaust gas components can be avoided by the effect of the high temperatures. Due to the high exhaust gas temperatures, the soot deposit in this region is also distinctly inferior to that in the region behind the exhaust gas cooler 18. For the aforementioned reasons, the direct measurement of the exhaust-gas mass flow will undergo only very slight measurement inaccuracies.

The exhaust gas will further flow from exhaust-gas mass flow sensor 24 to the exhaust gas cooler 18. On the cold inner walls of the latter, there is normally generated a considerable deposit of soot, which, however, is reduced by the upstream-connected oxidation catalyst by which the formation of hydrocarbon condensate on the walls is significantly decreased. The exhaust gas is cooled down within the exhaust gas cooler 18 so that a distinctly cooler exhaust gas/air mixture is made available to the suction channel 12 and thus to the external combustion engine, thereby allowing an improvement of combustion and a reduction of harmful substances.

The exhaust gas recirculation valve 20 is arranged downstream of the exhaust gas cooler 18 by which the exhaust gas quantity recirculated via the high-pressure exhaust gas recirculation duct 10 can be controlled. This can be performed, for example, by a comparison of the exhaust gas quantity measured by the exhaust gas mass flow sensor to the quantity stored corresponding to a characteristic diagram on the basis of existing motor data in the engine control device, so that the exhaust-gas mass flow sensor 24 has direct effects on the position of the exhaust gas recirculation valve 20.

The present invention therefore provides an exact measurement of the exhaust gas mass flow recirculated in the high-pressure exhaust gas recirculation duct, thus improving engine control.

It is to be understood that the protective scope of the present application is not restricted to the embodiment described above. Instead of the oxidation catalyst, other flow stabilizing elements can also be provided, wherein the arrangement downstream of the oxidation catalyst offers additional advantages. The exhaust gas recirculation system can also be used for other types of engines. Reference should be had to the appended claims.

What is claimed is:

1-6. (canceled)

7. An exhaust gas recirculation system for an internal combustion engine, the exhaust gas recirculation system comprising:
an exhaust gas duct;
a suction duct; and
an exhaust gas recirculation duct which branches off from the exhaust gas duct and which flows into the suction duct;
wherein
an exhaust gas mass flow sensor is arranged downstream of a flow stabilization element in the exhaust gas recirculation duct.

8. The exhaust gas recirculation system as recited in claim 7, further comprising an exhaust gas cooler and an exhaust gas recirculation valve arranged in the exhaust gas recirculation duct, the exhaust gas mass flow sensor being arranged upstream of the exhaust gas cooler and the exhaust gas recirculation valve.

9. The exhaust gas recirculation system as recited in claim 7, wherein the flow stabilization element is a catalyst arranged in the exhaust gas recirculation duct.

10. The exhaust gas recirculation system as recited in claim 9, wherein the catalyst is an oxidation catalyst.

11. The exhaust gas recirculation system as recited in claim 7, further comprising a turbine of a turbo charger and a condenser, wherein the exhaust gas recirculation duct is a high-pressure exhaust gas recirculation duct which branches off from the exhaust gas duct upstream of the turbine of a turbo charger and which flows into the suction duct downstream of the condenser.

12. The exhaust gas recirculation system as recited in claim 7, wherein the exhaust gas mass flow sensor operates according to a principle of hot-film anemometry.
